(19) United States
(12) Patent Application Publication
(10) Pub. No.: US 2015/0150215 A1
(43) Pub. Date: Jun. 4, 2015

(54) AUTOMATIC LIVESTOCK WATERER WITH HEATING SYSTEM

(71) Applicant: Andrew Pumphrey, Mankato, KS (US)

(72) Inventor: Andrew Pumphrey, Mankato, KS (US)

(21) Appl. No.: 14/093,894

(22) Filed: Dec. 2, 2013

(51) Int. Cl. A01K 7/02; A01K 7/04

(52) U.S. Cl. CPC A01K 7/027; A01K 7/04

(57) ABSTRACT

An automatic livestock waterer has a water trough, a float valve assembly, a water pump, and a heating system. The float valve assembly is positioned in the water trough to maintain a desired water level. The water pump has an inlet connected to a suction line for drawing water from a water source, such as a pond or stream, and an outlet for delivering water to the water trough via the float valve assembly. The heating system includes a gas burner located under the water trough for preventing water in the water trough from freezing during cold weather conditions. A rechargeable battery is connected to the water pump and the heating system for supplying power for pumping water and for electronic ignition of the gas burner. A housing supports the water trough in an elevated position above the ground and contains the heating system and water pump below the trough.

### BACKGROUND OF THE INVENTION

1. Field of the Invention

The present invention relates generally to animal waterers, and in particular, to automatic livestock waterers with heating systems to prevent freezing.

2. Description of the Related Art

Livestock, such as cattle, are often kept in pastures and feedlots in remote locations where access to electricity is not available. Proper care of the livestock requires a continuous and year-round supply of clean water. This is sometimes accomplished using windmills or electric pumps that pump groundwater into stock tanks, or ponds fed with spring water or the like.

During cold weather it is often necessary to either visit the stock watering tank or pond frequently to break ice, or to provide a heating system to prevent the water from freezing. However, it is inconvenient and sometimes impossible to visit the stock watering tank frequently enough to break and remove the ice. Also, there are only limited options for heating the water in locations where access to the electric power grid is either not available or prohibitively expensive.

Stock watering tank heaters are known in the art. For example, U.S. Pat. No. 2,561,932 issued to Landgraf discloses a floating electric heater that can be placed in a stock watering tank to prevent freezing. For another example, U.S. Pat. Nos. 3,703,167 and 4,154,225 issued to Maher disclose heaters for stock watering tanks that have a gas burner located under an auxiliary tank beside the stock watering tank.

Other examples of livestock waterers with heating systems are also known in the art. For example, U.S. Pat. No. 6,619,232 issued to Johnston et al. discloses a livestock waterer with an electric heating element that heats the air below a water reservoir to prevent freezing. For another example, U.S. Pat. No. 3,044,445 issued to Terry et al. discloses a livestock waterer with a gas burner located below the water rough.

In pastures where a pond or stream provide the water source for livestock, the livestock often damage the pond or stream bank by trampling down the bank to access the water. This can lead to problems with erosion of the bank, turbidity of the water, and silting in of the pond or stream.

There is a need in the industry for improved livestock waterers that provide a reliable year-round supply of water from existing water sources in remote locations.

### SUMMARY OF THE INVENTION

An object of the present invention is to provide a livestock waterer that can be used in remote locations without access to an electric power grid.

Another object of the present invention is to provide a livestock waterer that has an efficient gas heating system.

Another object of the present invention is to provide a livestock waterer that can be placed near an existing water source, such as a pond or stream, and used to deliver water from the existing water source while protecting the bank of the pond or stream from damage by the livestock.

Another object of the present invention is to provide a livestock waterer that uses a low voltage battery to power an on-demand water delivery pump and an ignition source for a gas heater.

To accomplish these and other objects of the present invention, an automatic livestock waterer is provided that has a water trough, a float valve assembly, a water pump, and a heating system. The float valve assembly is positioned in the water trough to maintain a desired water level in the trough. The water pump has an inlet connected to a suction line for drawing water from a water source, such as a pond or stream, and an outlet for delivering water to the water trough via the float valve assembly. The heating system includes a gas burner located under the water trough for preventing water in the water trough from freezing during cold weather conditions. A rechargeable battery is connected to the water pump and the heating system for supplying power for pumping water and for electronic ignition of the gas burner. A housing supports the water trough in an elevated position above the ground and contains the heating system and water pump below the trough.

According to one aspect of the present invention, an automatic livestock waterer is provided, comprising: a water trough; a float valve assembly positioned in the water trough for regulating a flow of water into the water trough to maintain a desired water level in the water trough; a water pump having an inlet connected to a suction line for drawing water from a water source, and an outlet connected to the float valve assembly for delivering water to the water trough; a heating system for preventing water in the water trough from freezing during cold weather conditions, the heating system comprising a gas burner located under the water trough, a gas valve and an electronic ignition device associated with the gas burner, a thermocouple for measuring a temperature of the water in the water trough, and a means for activating the ignition device and the gas valve to ignite the gas burner when the thermocouple detects a water temperature below a predetermined threshold temperature; and a battery connected to the water pump and the heating system for supplying power to operate the pump and the electronic ignition device.

According to another aspect of the present invention, an automatic livestock waterer is provided, comprising: a water trough; a float valve assembly positioned in the water trough for regulating a flow of water into the water trough to maintain a desired water level in the water trough; a heating system for preventing water in the water trough from freezing during cold weather conditions, the heating system comprising a gas burner located under the water trough, a gas valve and an electronic ignition device associated with the gas burner, a thermocouple for measuring a temperature of the water in the water trough, and an electric circuit for activating the ignition device and the gas valve to ignite the gas burner when the thermocouple detects a water temperature below a predetermined threshold temperature; and a battery connected to the heating system for supplying power to the electric circuit.

According to another aspect of the present invention, a remote livestock watering system is provided, comprising a water source and a waterer located a distance from the water source to protect the water source from being damaged by livestock. The waterer comprises: a water trough; a float valve assembly positioned in the water trough for regulating a flow of water into the water trough to maintain a desired water level in the water trough; a water pump having an inlet connected to a suction line that extends from the water source to the water pump for drawing water from the water source, and an outlet connected to the float valve assembly for delivering water to the water trough; a heating system for preventing water in the water trough from freezing during cold weather conditions, the heating system comprising a gas burner located under the water trough; and a battery connected to the water pump for supplying power to the water pump.

Numerous other objects of the present invention will be apparent to those skilled in this art from the following description wherein there is shown and described example embodiments of the present invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings.

In the drawings:

FIG. 1 is a perspective view of a remote livestock watering system using the automatic livestock waterer of the present invention.

FIG. 2 is an exploded parts view of the automatic livestock waterer of the present invention.

FIG. 3 is a cutaway elevation view of the automatic livestock waterer of the present invention.

### DETAILED DESCRIPTION OF THE INVENTION

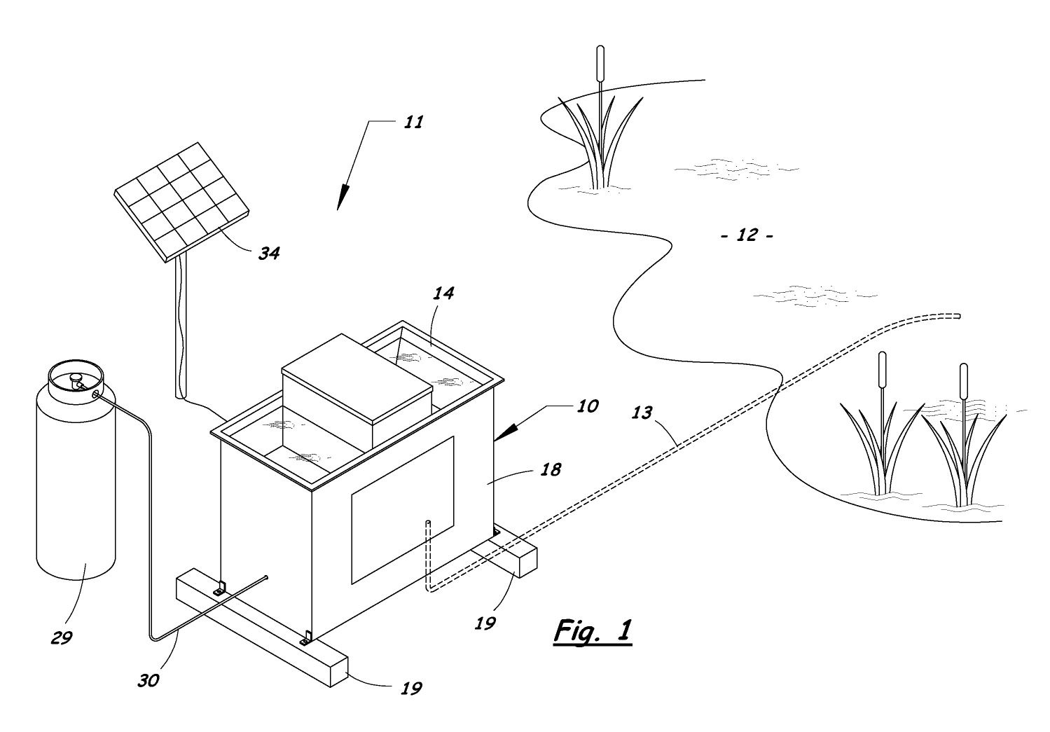

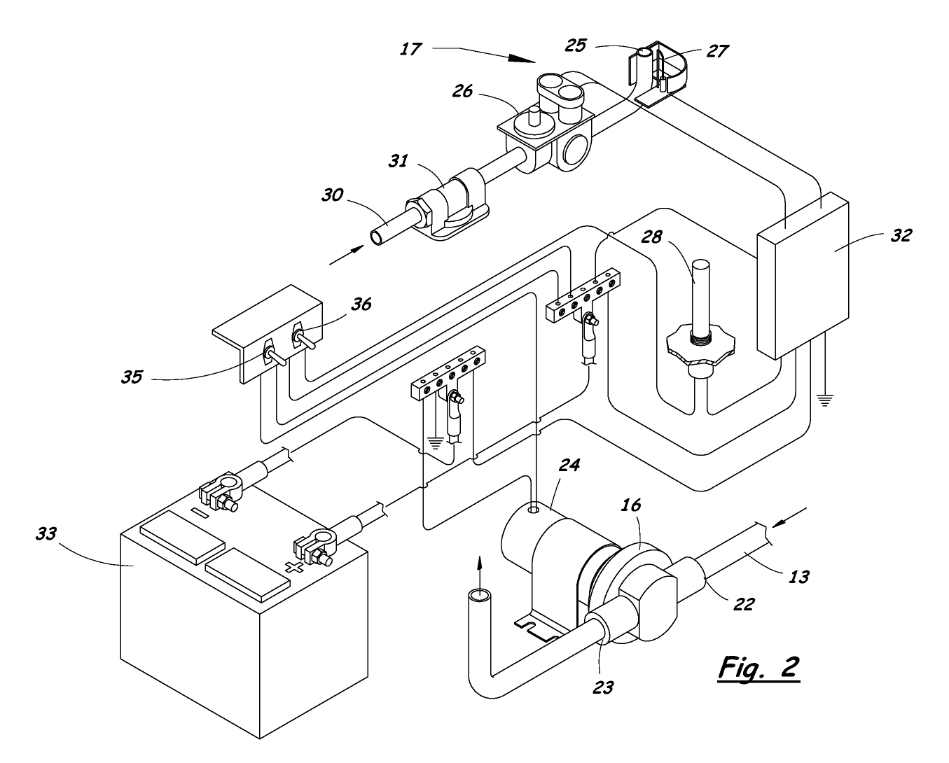

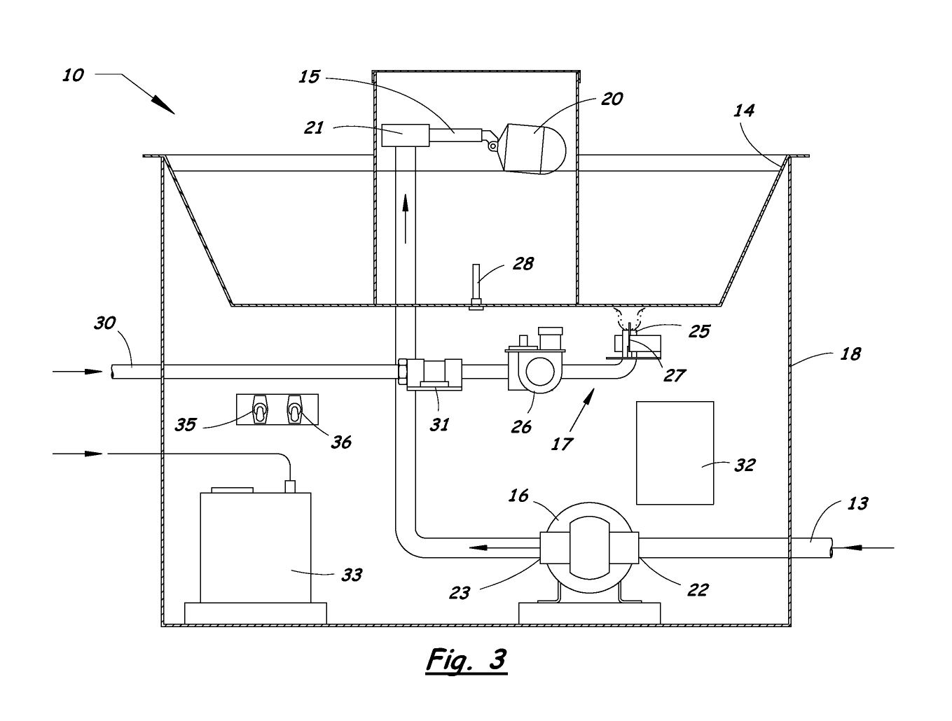

An automatic livestock waterer 10 according to the present invention is described in detail below with reference to FIGS. 1 to 3 of the accompanying drawings.

The waterer 10 is particularly suitable for use in a livestock watering system 11 for watering livestock in remote locations. The waterer 10 can be positioned near a surface water source 12, such as a pond or a stream, with a suction line 13 running from the water source 12 to the waterer 10 so that the livestock can drink from the waterer 10 instead of the water source 12 itself. This allows the livestock to drink without trampling the bank of the water source 12 or causing turbidity by walking through the water. If desired, a fence (not shown) can be erected to keep livestock out of the water source 12.

The waterer 10 includes a water trough 14, a float valve assembly 15, a water pump 16, and a heating system 17. A housing 18 supports the water trough 14 in an elevated position above the ground and contains and protects the heating system 17 and water pump 16 below the water trough 14. Insulation (not shown) can be added to the housing 18 to improve the efficiency of the heating system 17. Skids 19 can be mounted under the housing 18 to make the waterer 10 easier to move with a pickup truck, a tractor loader or the like.

The float valve assembly 15 is positioned in the water trough 14 for regulating a flow of water into the water trough 14 to maintain a desired water level. The float valve assembly 15 includes a float 20 and a valve 21 connected to and operated by the float 20. The valve 21 opens to deliver water into the water trough 14 when the float 20 determines that the water level in the water trough 14 is low.

The water pump 16 has an inlet 22 connected to the suction line 13 for drawing water from the water source 12, and an outlet 23 for delivering water to the water trough 14 via the float valve assembly 15. The water pump 16 has a built-in pressure switch that activates the pump 16 when a water pressure at the pump outlet 23 is below a predetermined pressure. For example, the pressure switch can be made to activate the pump 16 whenever the water pressure at the pump outlet 23 is below 40 psi, and deactivate the pump 16 whenever the water pressure is at or above 40 psi. When the float valve 21 opens, the pressure in the pump outlet 23 will fall below 40 psi, thereby causing the pump 16 to be activated and water to be pumped from the water source 12 and delivered through the float valve assembly 15 into the water trough 14. Since the pump 16 is only activated on demand by the livestock, the pump 16 does not require a great deal of electricity for operation. The water pump 16 has a low voltage electric motor 24, such as a 12V motor. The water pump 16 can be, for example, a Jabsco PAR-Max Plus Automatic Water System Pump Model 82600-292.

The heating system 17 includes a gas burner 25 located under the water trough 14 for preventing water in the water trough 14 from freezing during cold weather conditions. A gas valve 26 and electronic ignition device 27 are associated with the gas burner 25. A thermocouple 28 is provided for measuring a temperature of the water in the water trough 14 to determine when heat is needed to prevent the water from freezing. A propane tank 29 or other suitable gas supply provides a fuel source for the gas burner 25. A gas line 30 delivers propane gas from the propane tank 29 to the gas valve 26 via a pressure regulator 31.

An electronic circuit module 32 is provided for controlling the gas valve 26 and the electronic ignition device 27 in response to a demand signal received from the thermocouple 28. When the thermocouple 28 detects a water temperature below a predetermined threshold temperature (e.g., 32 to 45 degrees F.), a demand signal is sent from the thermocouple 28 to the electronic circuit module 32, and the module 32 then sends a control voltage to the ignition device 27 and the gas valve 26 to operate the gas burner 25. Once the thermocouple 28 detects a water temperature above the predetermined threshold temperature, the demand signal is discontinued and the gas valve 26 is closed.

The heating system 17 does not use a pilot flame to ignite the gas burner 25. Instead, the heating system 17 uses the electronic ignition device 27 to ignite the gas burner 25, thereby conserving the limited gas supply.

A rechargeable battery 33 is connected to the water pump 16 and the heating system 17 for supplying power for pumping water and for electronic ignition of the gas burner 25. The rechargeable battery 33 is preferably a low voltage battery, such as a 12-volt automotive battery. A solar-powered battery charger 34 is connected to the battery 33 to maintain an adequate charge in the battery 33.

A first ON/OFF switch 35 is associated with the water pump 16 for selectively interrupting an electric circuit between the battery 33 and the water pump 16. The first ON/OFF switch 35 has an input connected to the positive terminal of the battery 33 and an output connected to one of the electrical leads of the electric motor 24 of the water pump 16.

A second ON/OFF switch 36 is associated with the heating system 17 for selectively interrupting an electric circuit between the battery 33 and the heating system 17. The second ON/OFF switch 36 has an input connected to the positive terminal of the battery 33 and an output connected to one of the electrical leads of the thermocouple 28.

As described above, the livestock waterer 10 of the present invention is self-contained with its own supply of electricity and gas so that the waterer 10 can be used in remote locations without an existing source of electricity, gas or pressurized water. The electronic ignition makes the heating system 17 extremely efficient so that the limited gas supply in the propane tank 29 can be conserved to last as long as possible. The electric water pump 16 allows the waterer 10 to use an existing water source 12, such as a pond or stream, while avoiding damaging the water source 12 or harming the water quality.

While the invention has been specifically described in connection with specific embodiments thereof, it is to be understood that this is by way of illustration and not of limitation, and the scope of the appended claims should be construed as broadly as the prior art will permit.

What is claimed is:

1. An automatic livestock waterer, comprising:
a water trough;
a float valve assembly positioned in said water trough for regulating a flow of water into said water trough to maintain a desired water level in said water trough;
a water pump having an inlet connected to a suction line for drawing water from a water source, and an outlet connected to said float valve assembly for delivering water to said water trough;
a heating system for preventing water in said water trough from freezing during cold weather conditions, said heating system comprising a gas burner located under said water trough, a gas valve and an electronic ignition device associated with said gas burner, a thermocouple for measuring a temperature of the water in said water trough, and a means for activating said ignition device and said gas valve to ignite said gas burner when the thermocouple detects a water temperature below a predetermined threshold temperature; and
a battery connected to said water pump and said heating system for supplying power to operate said pump and said electronic ignition device.

2. The livestock waterer according to claim 1, wherein said battery is a 12 volt battery.

3. The livestock waterer according to claim 1, wherein said water pump comprises a pressure switch that activates the pump when a water pressure at the pump outlet is below a predetermined pressure.

4. The livestock waterer according to claim 1, further comprising a first ON/OFF switch associated with said water pump for selectively interrupting an electric circuit between said battery and said water pump.

5. The livestock waterer according to claim 4, further comprising a second ON/OFF switch associated with said heating system for selectively interrupting an electric circuit between said battery and said heating system.

6. The livestock waterer according to claim 1, further comprising a solar battery charger connected to said battery.

7. The livestock waterer according to claim 1, wherein said means for activating said ignition device and said gas valve comprises an electronic circuit module that receives a demand signal from said thermocouple and sends a control voltage to said ignition device and said gas valve.

8. The livestock waterer according to claim 1, further comprising a housing that supports said trough in an elevated position above the ground, and wherein said water pump and said heating system are contained within said housing below said trough.

9. The livestock waterer according to claim 1, further comprising a propane tank and a gas line connected between said propane tank and said gas valve for supplying gas to said heating system.

10. The livestock waterer according to claim 1, wherein said waterer is self-contained with its own supply of electricity and gas so that said waterer can be used in remote locations without an existing source of electricity or pressurized water.

11. The livestock waterer according to claim 1, wherein said water source is a pond, and wherein said suction line extends from the pond to said water pump to allow said waterer to be positioned a distance away from the pond to protect the pond from being damaged by livestock.

12. An automatic livestock waterer, comprising:
a water trough;
a float valve assembly positioned in said water trough for regulating a flow of water into said water trough to maintain a desired water level in said water trough;
a heating system for preventing water in said water trough from freezing during cold weather conditions, said heating system comprising a gas burner located under said water trough, a gas valve and an electronic ignition device associated with said gas burner, a thermocouple for measuring a temperature of the water in said water trough, and an electric circuit for activating said ignition device and said gas valve to ignite said gas burner when the thermocouple detects a water temperature below a predetermined threshold temperature; and
a battery connected to said heating system for supplying power to said electric circuit.

13. The livestock waterer according to claim 12, further comprising a water pump having an inlet connected to a suction line for drawing water from a water source, and an outlet connected to said float valve assembly for delivering water to said water trough, said water pump being connected to and powered by said battery.

14. The livestock waterer according to claim 12, further comprising an ON/OFF switch associated with said heating system for selectively interrupting a circuit between said battery and said heating system.

15. The livestock waterer according to claim 12, further comprising a solar battery charger connected to said battery.

16. The livestock waterer according to claim 12, wherein said electric circuit is arranged to receive a demand signal from said thermocouple and send a control voltage to said ignition device and said gas valve.

17. The livestock waterer according to claim 12, further comprising a housing that supports said trough in an elevated position above the ground, and wherein said heating system is contained within said housing below said trough.

18. The livestock waterer according to claim 12, further comprising a propane tank and a gas line connected between said propane tank and said gas valve for supplying gas to said heating system.

19. The livestock waterer according to claim 12, wherein said waterer is self-contained with its own supply of electricity and gas so that said waterer can be used in remote locations without an outside source of electricity.

20. A remote livestock watering system, comprising:
a water source;
a waterer located a distance from said water source to protect the water source from being damaged by livestock, said waterer comprising:
a water trough;
a float valve assembly positioned in said water trough for regulating a flow of water into said water trough to maintain a desired water level in said water trough;
a water pump having an inlet connected to a suction line that extends from said water source to said water pump for drawing water from said water source, and an outlet connected to said float valve assembly for delivering water to said water trough;
a heating system for preventing water in said water trough from freezing during cold weather conditions, said heating system comprising a gas burner located under said water trough; and
a battery connected to said water pump for supplying power to said
